(19) United States
(12) Patent Application Publication
(10) Pub. No.: US 2018/0253762 A1
(43) Pub. Date: Sep. 6, 2018

(54) COGNITIVE METHOD TO SELECT A SERVICE

(71) Applicant: INTERNATIONAL BUSINESS MACHINES CORPORATION, ARMONK, NY (US)

(72) Inventors: Swaminathan Balasubramanian, Troy, MI (US); Thomas G. Lawless, III, Wallkil, NY (US); Jason R. Malinowski, Brentwood, TN (US); Cheranellore Vasudevan, Bastrop, TX (US)

(21) Appl. No.: 15/449,397

(22) Filed: Mar. 3, 2017

(51) Int. Cl. G06Q 30/02

(52) U.S. Cl. CPC G06Q 30/0269; G06Q 50/12; G06Q 30/0255

(57) ABSTRACT

Embodiments of the invention include method, systems and computer program products for selecting a service. Aspects include includes receiving, by a processor, customer data. External data is also received, wherein the external data includes social media posts associated with one or more services. Based at least in part on the social media posts, one or more patterns are determined for one or more services. Based at least in part on the customer data, a customer preference for a service environment is determined. A list of service recommendations is created based at least in part on the customer preferences and the one or more patterns.

### BACKGROUND

The present disclosure relates to selection of a service and, more specifically, to cognitive methods to select services using an analytical model.

Restaurant reviews and restaurant guidance can influence potential customers to visit a particular restaurant or food service. Additionally, other service industry companies, such as, for example hair stylists, massage therapists, and the like, can have business impacts based on reviews. A restaurant owner would prefer an accurate portrayal of their business to provide better service to a customer and to set a customer's expectations. A customer might want a review and guide to include the quality of the food at a restaurant, the ambiance, the dress code, average costs per meal, and other factors that might better educate a customer as to their choices in restaurants.

Available services exist that provide reviews and guidance about service businesses that include a plethora of information about the business. Despite this large amount of information, a customer can feel overwhelmed with choices and have no understanding of the best service option for them on any given day based on their needs at the particular time. Furthermore, in the case of a restaurant, the restaurant might have been at one point a dine-in only service and might now offer pre-order and pickup services, which adds to the options available to a customer.

### SUMMARY

Embodiments of the invention include a computer-implemented method for selecting a service. In a non-limiting example embodiment of the invention, the method includes receiving, using a processor, customer data. External data is also received, wherein the external data includes social media posts associated with one or more services. Based at least in part on the social media service, one or more patterns are determined for one or more services. Based at least in part on the customer data, a customer preference for a service environment is determined. A list of service recommendations is created based at least in part on the customer preferences and the one or more patterns.

Embodiments of the invention include a computer system for selecting a service, the computer system having a processor, the processor configured to perform a method. In a non-limiting example embodiment of the invention, the method includes receiving customer data. External data is also received, wherein the external data includes social media posts associated with one or more services. Based at least in part on the social media posts, one or more patterns are determined for one or more services. Based at least in part on the customer data, a customer preference for a service environment is determined. A list of service recommendations is created based at least in part on the customer preferences and the one or more patterns.

Embodiments of the invention also include a computer program product for selecting a service, the computer program product including a non-transitory computer readable storage medium having computer readable program code embodied therewith. The computer readable program code including computer readable program code configured to perform a method. In a non-limiting example embodiment of the invention, the method includes receiving customer data. External data is also received, wherein the external data includes social media posts associated with one or more services. Based at least in part on the social media posts, one or more patterns are determined for one or more services. Based at least in part on the customer data, a customer preference for a service environment is determined. A list of service recommendations is created based at least in part on the customer preferences and the one or more patterns.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 depicts a cloud computing environment according to one or more embodiments of the present invention;

FIG. 2 depicts abstraction model layers according to one or more embodiments of the present invention;

FIG. 3 illustrates a block diagram of a computer system for use in practicing the teachings herein;

FIG. 4 illustrates a block diagram of a system for selecting a service in accordance with one or more embodiments of the invention; and

FIG. 5 illustrates a flow diagram of a method for selecting a service in accordance with one or more embodiments of the invention.

### DETAILED DESCRIPTION

In accordance with exemplary embodiments of the present invention, methods, systems and computer program products for selecting a food service are provided. Aspects include receiving customer information for a potential customer of a food service. The food service can include any type of dine-in restaurant, to-go only restaurant, a food delivery service, and the like. Pattern information, which can be retrieved from social media websites or any other review websites that are associated with service business, is utilized to develop a pattern associated with a service business. For example, a restaurant that is crowded on certain nights of the week can be predicted through social media data or posts about the crowdedness of the restaurant and correlates this information to the time of day and the day of the week to establish a pattern. These patterns can be analyzed and cross referenced with customer preferences to determine a service recommendation. For a restaurant service, customer preferences include food type preference, timing and availability, and physiological data, such as stress level. The customer preferences are analyzed with patterns associated with a service business to further develop recommendations for the customer. For example, a customer could input data indicating a dining atmosphere preference (e.g., quiet) that would bring up a list of food services that provide that type of dining atmosphere. This list of food services would then be augmented based at least in part on the customer data and external data, such as the social media data pulled from social media websites mentioning the food service. Should the external data show that a particular food service has a live band or other potentially loud atmosphere, that particular food service can be dropped from the list of recommendations or moved down on the list.

A service context is developed for the customer based at least in part on the customer information. The customer information can include historical data about the customer as it relates to services previously received. Additional customer information can include data received from a customer's calendar and social media to further define the service context. For example, a first date can be specified on a customer's calendar around the time the customer is looking for a movie theater. Based on this service context, movie theaters and even movies that are suitable for an enjoyable first date are selected and presented to the customer.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model can include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but can be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It can be managed by the organization or a third party and can exist on-premises or off-premises.

Community cloud: the cloud infrastructure is shared by several organizations and supports a specific community that has shared concerns (e.g., mission, security requirements, policy, and compliance considerations). It can be managed by the organizations or a third party and can exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

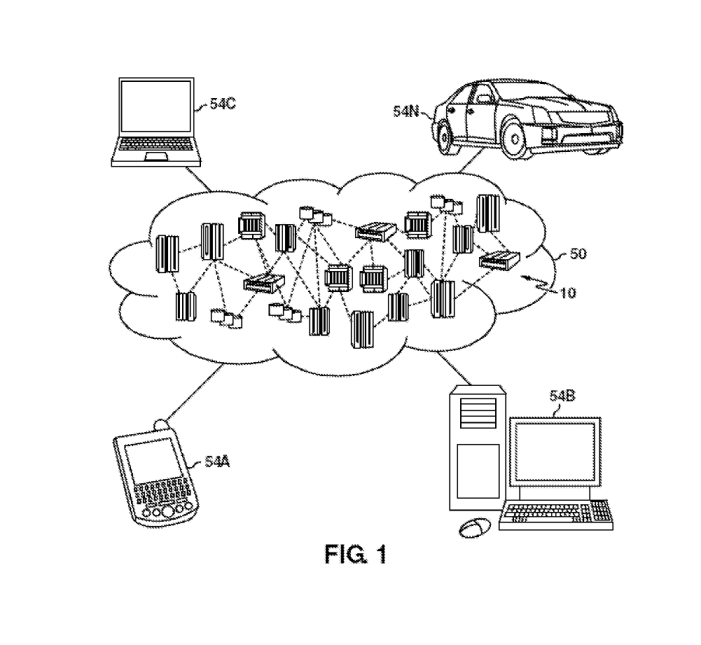

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N can communicate. Nodes 10 can communicate with one another. They can be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

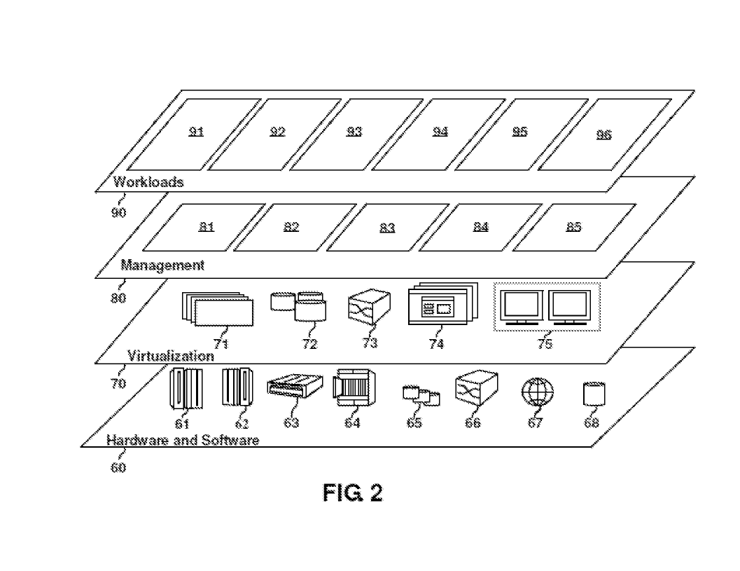

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments of the invention, software components include network application server software 67 and database software 68.

Virtualization layer 70 provides an abstraction layer from which the following examples of virtual entities can be provided: virtual servers 71; virtual storage 72; virtual networks 73, including virtual private networks; virtual applications and operating systems 74; and virtual clients 75.

In one example, management layer 80 can provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources can comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment can be utilized. Examples of workloads and functions which can be provided from this layer include: mapping and navigation 91; software development and lifecycle management 92; virtual classroom education delivery 93; data analytics processing 94; transaction processing 95; and selecting a food service 96.

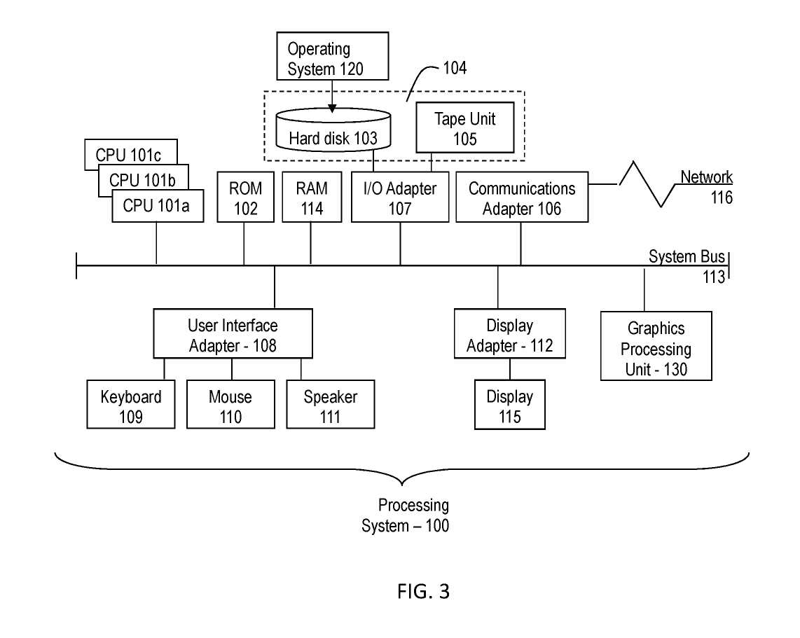

Referring to FIG. 3, there is shown an embodiment of a processing system 100 for implementing the teachings herein. In this embodiment, the system 100 has one or more central processing units (processors) 101a, 101b, 101c, etc. (collectively or generically referred to as processor(s) 101). In one or more embodiments of the invention, each processor 101 can include a reduced instruction set computer (RISC) microprocessor. Processors 101 are coupled to system memory 114 and various other components via a system bus 113. Read only memory (ROM) 102 is coupled to the system bus 113 and can include a basic input/output system (BIOS), which controls certain basic functions of system 100.

FIG. 3 further depicts an input/output (I/O) adapter 107 and a network adapter 106 coupled to the system bus 113. I/O adapter 107 can be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 can be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which can include a graphics adapter to improve the performance of graphics intensive applications and a video controller. In one embodiment, adapters 107, 106, and 112 can be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which can include, for example, a Super I/O chip integrating multiple device adapters into a single integrated circuit.

In exemplary embodiments, the processing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing and has a highly parallel structure that makes it more effective than general-purpose CPUs for algorithms where processing of large blocks of data is done in parallel.

Thus, as configured in FIG. 3, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system coordinate the functions of the various components shown in FIG. 3.

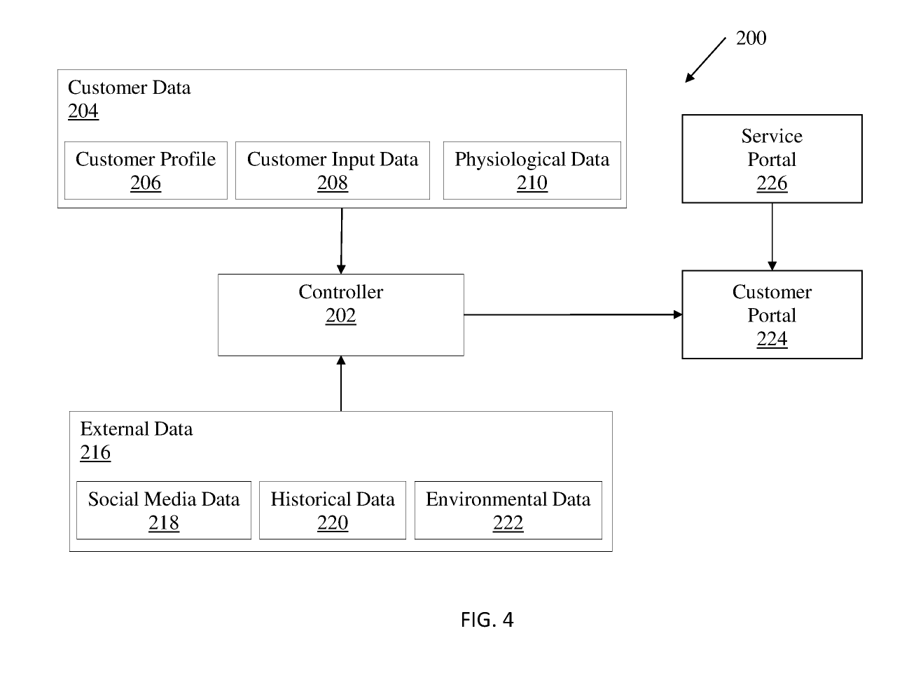

Referring to FIG. 4 there is shown a system 200 for selecting a service according to one or more embodiments of the invention. The system 200 includes a controller 202 that receives data inputs including customer data 204 and external data 216 and outputs to a customer portal 224. The controller 202 analyzes the inputs to determine a list of food service recommendations for a customer based upon the inputted data. The customer portal 224 includes a display that displays a list of service recommendations to a customer.

In one or more embodiments of the invention, the controller 202 can be implemented on the processing system 100 found in FIG. 3. Additionally, the cloud computing system 50 can be in wired or wireless electronic communication with one or all of the elements of the system 200. Cloud 50 can supplement, support or replace some or all of the functionality of the elements of the system 200. Additionally, some or all of the functionality of the elements of system 200 can be implemented as a node 10 (shown in FIGS. 1 and 2) of cloud 50. Cloud computing node 10 is only one example of a suitable cloud computing node and is not intended to suggest any limitation as to the scope of use or functionality of embodiments of the invention described herein.

Included in the customer data 204 is a customer profile 206, data taken from a customer input 208, and physiological data 210. The customer profile 206 includes information about the customer, such as food preferences. The customer profile 206 can include the customer' s calendar data taken from an electronic calendar which would provide the customer's availability for visiting a service. The customer's availability can limit the service options because of timing constraints on the customer. If a customer is selecting a food service, certain food types can be restricted based at least in part on the customer's calendar indicating that the customer has physical activity schedule afterward. For example, a customer might prefer a lighter meal before going to tennis practice or the like. The customer profile 206 can include historical data about the customer and the customer's eating habits. The customer profile 206 can include the customer's most recent meal and the controller 202 can consider the information about the most recent meal to help determine a food service for the customer's dinner. Based at least in part on the historical data in the customer's profile 206, the controller 202 can analyze recent meals, dining constraints, and a customer preference to determine food service options for the customer. For example, historical data for a customer might indicate the customer had an unhealthy lunch and would make recommendations for a healthier food service option for dinner.

In one of more embodiments of the present invention, the customer data 204 can include physiological data 210 taken from a physiological sensor such as a heart monitor, blood pressure monitor or other similar sensor either wearable or in electronic communication with a smart device such as a phone or laptop. The physiological data 210 can include wellness data or any abnormal conditions about the customer, such as high blood pressure and stress level. This physiological data 210 can be utilized to determine service options that would help alleviate the high blood pressure or stress level. For example, a customer under stress can be provided with a list of food service options that have a quiet noise level and a peaceful ambiance. Or a customer with high blood pressure could be provided with a list of food service recommendations that have healthier options.

For a customer selecting a food service, the customer can provide customer input data 208 that includes service context data such as, for example, hunger level of the customer, the customer's previous meals from earlier in the day, week, or month, and the amount of time a customer has available for dining. Additional dining context data can include a dining type that specifies whether the dining experience will include friends and family or whether the customer is meeting a client for a business lunch or dinner. Examples of dining types include personal and business meals as well as any personal commitments at or near the time of the dining experience. For example, commitments such as a conference call schedule near the time of the customer's lunch or dinner or a customer can have movie tickets for a show time near the time of the customer's lunch or dinner. A dining type can also specify whether the meal will be attended solely by the customer or if the customer will have guests. For example, a dining type specifying the meal as a first or second date would look at the data associated with the food service (e.g., social media data 218, historical data 220, and environmental data 222) to determine if the food service would be appropriate for a first or second date. Some considerations can include the ambiance, the noise level, and the relative crowdedness of the food service at the time of the meal.

In one or more embodiments of the invention, dining context and dining type can be derived from the customer data 204 without any data provided through the customer input 208. Customer data 204 such as electronic calendar data can be utilized to derive a context and dining type based at least in part on categorization of the customer's schedule meetings. For example, if a customer has calendar entry for a lunch during the work week, the dining context can be set to a business lunch based at least in part on the context taken from the electronic calendar data.

In one or more embodiments of the invention, the controller 202 utilizes web crawling techniques, or any other suitable techniques, on various social media websites (including restaurant review websites) to determine service patterns. The service patterns include real time information such as, for example, noise conditions. These patterns can be presented to the service and, based at least in part on these patterns indicating noisy conditions; a food service could offer a customer a private booth in the back of the restaurant to guarantee a quiet and calm dining experience for customers that indicate they want a quiet dining experience. These patterns can be visible to the services through the service portal 226 or any other suitable medium. The services can offer various incentives to customers based at least in part on customer preferences. For example, if a large number of customers indicate they wish to have a quick, take-out meal, the restaurant could offer coupons for dine-out customers.

External data 216 is also utilized to develop a pattern for services that includes crowdedness during certain time periods or days, noise levels at various times, service quality and speediness. Social media data 218 is included in the external data to augment or update the service patterns. For example, if a pattern has been developed for a pizza restaurant stating it is loud and crowded on Thursday nights, social media data 218 taken during Thursday night can either validate this pattern or update the pattern based at least in part on real time social media posts tagging the restaurant and stating that the restaurant is quiet and empty. In addition to social media data 218, historical data 220 is provided to develop a pattern for a service. For example, if historically, food service speed has been slow, then a pattern can be developed to determine a list of food service recommendations when a customer has a short amount of time to eat. Environmental data 222 can help determine a pattern for a service. For example, when it is raining out, a food service that has a large patio might not be able to accommodate as many customers and would make the inside seating more crowded. This pattern can be developed for any type of weather condition. For example, nicer weather and temperatures can encourage more customers to go to services with large outside patios which can cause changes to noise levels.

In one or more embodiments of the invention, the controller 202 utilizes the customer data 204 and external data 216 to develop a list of service recommendations and present to a potential customer via a customer portal 224. The customer portal 224 can be implemented on a computer, tablet, phone or any other smart device. In an another embodiment, a service portal 226 can receive inputs from services, such as restaurants, to present promotions, discounts, and/or coupons to a customer to incentivize the customer.

In one or more embodiments of the invention, the system 200 will gather information from social media and other review sites to determine a pattern of the conditions within the service location. By processing the text from the reviews, the system 200 determines factors like the predicted and current experience noise level, service quality, and wait-times based at least in part on a customer's descriptions using concept analytics. The cognitive text analysis, employed by the controller 202, will interpret the review text to understand the conditions which results in the noise level, service quality, and wait time. For example, when someone speaks about how crowded a place was last night and the review was posted on Wednesday, the system will recognize that the restaurant was likely noisy on Tuesday night. In addition, if others post on Thursday about how their service was slow this past Tuesday, then the system will again associate the poor service with the busy location on that day/time. These patterns establish a predicted profile of the ambiance quality metrics which can be stored in a cloud database for usage in the service choice selection. When a customer decides to search, via the customer portal 224, for something to eat, they will be presented with the list of matches. This is then augmented with the list of service recommendations. Real time conditions of the user can also be taken into consideration including their current stress level, patterns of dining in or eating out plus what the customer personally considers positive dining experiences (taken from the customer data 204). For a food service selection, the predicted and current conditions in the service location are matched against the dynamic conditions and intentions of the user such as time available, level of hunger, what was eaten previously, type of meal, etc. The personalized recommendation will inform the customer if a given restaurant of choosing is best for dine in, dine out, delivery, or for utilizing a third party order experience.

In one or more embodiment, the system 200 will gather feedback/comments from social media sources such as Facebook®, Google®, Yelp®, etc. and can be updated in real time. Social media functionality such as check-ins or GPS positioning can be used to determine how many people are likely in a given service location at any point in time. Characteristics can then be predicted about the service on a given date and time. For example, is the bar historically noisy on a Tuesday night? Or does it have slow service on a Friday night? These characteristics can determine if a customer will have a pleasant experience based upon their customer preference taken and developed from the customer data 204. These predictions can be correlated with the current occupancy metrics to determine if the experience is matching a typical time period or not. This will feed into the certainty of the prediction. For a set of predicted patterns, the application of these patterns can be different based at least in part on the needs of the customer. The system can take into account what the customer has eaten earlier in the day, where they need to go after they eat, plus the dining ambiance preference based at least in part on the customer's personal or health goals, for example.

In one or more embodiments of the invention, the system 200 can also use health, stress, diet, and menu interest information to help the user decide if they should dine in or carry out for any given restaurant at a specific point in time as taken from the customer profile 206. If a customer's visits to a noisy restaurant raise the customer's levels of stress, the system 200 could recommend against a restaurant which has a pattern of being noisy at the given time. Data from customer inputs 208 and physiological data 210 such as individual instantaneous health conditions, such as headaches, stomach problems, sugar levels, diet conditions, and stress, can also be used to factor in food service selection and recommendations.

Customer inputs 208 such as specific menu items which take a long time to cook. A recommendation for dining-in can be made to account for the time it takes to prepare said menu item. Other inputs include what a customer has eaten earlier in the day, what a customer will do immediate after the meal such as exercising at a gym, working late night, and going to sleep can be taken to update or augment a list of food service recommendations. Cost implications of a customer's choice of food services can also be considered. A customer can configure a preference in the customer profile 206 or as a customer input 208 for how much cost difference is acceptable for the best option. For example, would a 15% cost increase be acceptable for a delivery service to avoid a noisy, busy restaurant with poor service on this given date/time.

In one or more embodiments of the invention, when a customer reviewing the list of potential food service recommendations, the food service portal 226 enables one or more restaurants to offer them an incentive. The one or more restaurants would have access to potential menu items a customer can choose from on their published menu plus the characteristics a customer might want in a dining experience. In addition, the system 200 could provide the characteristics the restaurant needs to provide.

In one or more embodiments of the present invention, the customer profile 206 can include information about a customer such as preferences for a particular service, such as food type preferences. Also, the customer profile 206 can include restrictions such as religious restrictions that would restrict certain activities related to a service location. For example, some religions have restrictions on eating meat during certain days of the week which would assist the controller 202 in determining a food service selection for a customer on that particular day.

In one or more embodiments of the present invention, the customer data 204 can include a customer's calendar data which can help develop a service context for the customer. For example, if a calendar invite has a work email address of an invitee to the calendar event, the context can determine this to be a business lunch based at least in part on the amount of time that is blocked off for the calendar event and the description used, such as “Lunch with George”. When selecting a food service, this context from the calendar event can be utilized to select a work appropriate dining experience. Another example includes a calendar invite entitled, “Fantasy Football Draft,” and includes personal email addresses for the invitees. The context developed from this can include a social dining experience that would benefit from a sports themed restaurant with plenty of space and good lighting.

In one or more embodiment of the present invention, the context for the service can be developed from historical data taken from the customer profile 206. Certain service habits, such as getting a haircut every month can be included in the customer profile 206. Services can be predicted as being needed at or around the time the service habit occurs. Also, monthly dinners with customer's parents can also be included in the historical data and can assist in determining a service need for a customer at or around the time of the usual monthly dinner. Additionally, a context such as the customer is travelling can be developed from the customer data. During this travel period, service recommendations can be for restaurants that are along the travel route of the customer.

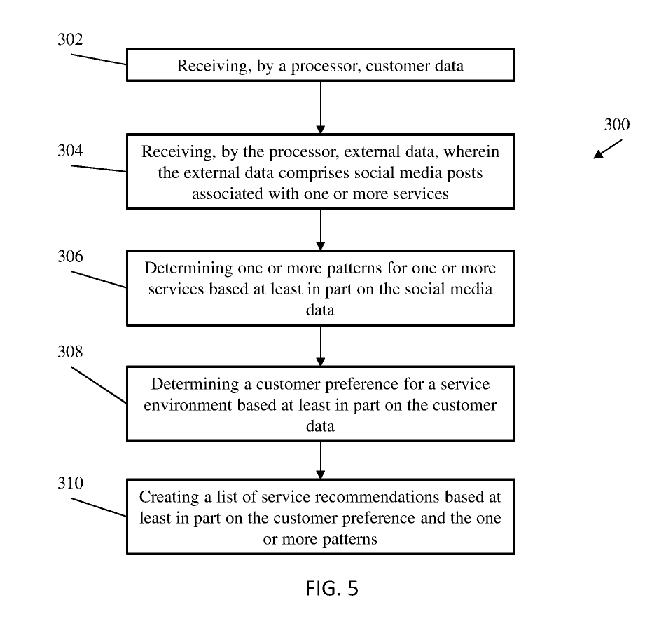

Referring now to FIG. 5 there is shown a flow diagram of a method 300 for selecting a service according to one or more embodiments of the invention. The method 300 includes receiving, by a processor, customer data, as shown at block 302. The method 300, at block 304, includes receiving, by the processor, external data, wherein the external data comprises social media posts associated with one or more services. At block 306, the method 300 includes determining one or more patterns for one or more services based at least in part on the social media data. The method 300 includes determining a customer preference for a service environment based at least in part on the customer data, as shown at block 308. At block 310, the method 300 includes creating a list of food service recommendations based at least in part on the customer preference and the one or more patterns

Additional processes can also be included. It should be understood that the processes depicted in FIG. 5 represent illustrations, and that other processes can be added or existing processes can be removed, modified, or rearranged without departing from the scope and spirit of the present disclosure.

The present invention can be a system, a method, and/or a computer program product. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting-data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments of the invention, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for selecting a service, the method comprising:
receiving, by a processor, customer data, the customer data comprising a customer profile;
receiving, by the processor, external data, wherein the external data comprises social media posts associated with one or more services;
determining one or more patterns for one or more services based at least in part on the social media data;
determining a customer preference for a service environment based at least in part on the customer profile; and
creating a list of service recommendations based at least in part on the customer preference and the one or more patterns.

2. The method of claim 1, wherein the customer data comprises service context data for a customer.

3. The method of claim 2, wherein the service context data comprises at least one of a time constraint for service and a service type.

4. The method of claim 1, wherein the external data further comprises environmental data and further comprising:
updating the one or more patterns for the one or more services based at least in part on the environmental data;
updating the list of service recommendations based at least in part on the customer preferences and the one or more patterns.

5. The method of claim 1, wherein the customer data comprises physiological data about the customer and further comprising:
updating the customer preference for a service environment based at least in part on the physiological data; and
updating the list of service recommendations based at least in part on the customer preferences and the one or more patterns.

6. The method of claim 1, wherein the customer data comprises customer calendar data and further comprising:
updating the customer preference for a service environment based at least in part on the customer calendar data; and
updating the list of service recommendations based at least in part on the customer preference and the one or more patterns.

7. The method of claim 1, wherein the external data comprises historical data about the one or more services and further comprising:
updating the one or more patterns for the one or more services based at least in part on the historical data; and
updating the list of service recommendations based at least in part on the customer preference and the one or more patterns.

8. The method of claim 1, wherein the one or more patterns comprise at least one of an ambience of a service location, noise level of a service location, service speed of a service location, and quality of a service.

9. The method of claim 1, further comprising:
displaying, by a display screen, the list of service recommendations to a customer.

10. The method of claim 9, wherein the display screen comprises at least one of a phone screen, a tablet screen, and a computer screen

11. The method of claim 1, further comprising:
receiving one or more promotions for a service on the list of service recommendations.

12. The method of claim 1, wherein the customer data comprises a customer historical data and further comprising:
updating the customer preference for a service environment based at least in part on the customer historical data; and
updating the list of service recommendations based at least in part on the customer preference and the one or more patterns.

13. A computer system for selecting a service, the computing system including a processor communicatively coupled to a memory, the processor configured to:
receive customer data, the customer data comprising a customer profile;
receive external data, wherein the external data comprises social media posts associated with one or more services;
determine one or more patterns for one or more services based at least in part on the social media data;
determine a customer preference for a service environment based at least in part on the customer profile; and
create a list of service recommendations based at least in part on the customer preference and the one or more patterns.

14. The system of claim 13, wherein the customer data comprises a service context data for a customer.

15. The system of claim 14, wherein the service context data comprises at least one of a time constraint for a service and a service type.

16. The system of claim 13, wherein the external data further comprises environmental data and the processor is further configured to:
update the one or more patterns for the one or more services based at least in part on the environmental data; and
update the list of service recommendations based at least in part on the customer preferences and the one or more patterns.

17. The system of claim 13, wherein the customer data comprises physiological data about the customer and the processor is further configured to:
update the customer preference for a service environment based at least in part on the physiological data; and
update the list of service recommendations based at least in part on the customer preferences and the one or more patterns.

18. A computer program product for selecting a service, the computer program product comprising a computer readable storage medium having program instructions embodied therewith, the program instructions executable by a processor to cause the processor to perform:
receiving, by a processor, customer data, the customer data comprising a customer profile;
receiving, by the processor, external data, wherein the external data comprises social media posts associated with one or more services;
determining one or more patterns for one or more services based at least in part on the social media data;
determining a customer preference for a service environment based at least in part on the customer profile; and
creating a list of service recommendations based at least in part on the customer preference and the one or more patterns.

19. The computer program product of claim 18, wherein the customer data comprises a service context data for a customer.

20. The computer program product of claim 18, wherein the external data comprises historical data about the one or more services and further comprising:
updating the one or more patterns for the one or more services based at least in part on the historical data; and
updating the list of service recommendations based at least in part on the customer preference and the one or more patterns.
